(19) United States
(12) Patent Application Publication
(10) Pub. No.: US 2012/0229680 A1
(43) Pub. Date: Sep. 13, 2012

(54) ELECTRONIC DEVICE HAVING OPERATING PORTION

(75) Inventor: Yasuhiro Nakatsu, Osaka-shi (JP)

(73) Assignee: SANYO ELECTRIC CO., LTD., Osaka (JP)

(21) Appl. No.: 13/413,123

(22) Filed: Mar. 6, 2012

(30) Foreign Application Priority Data
Mar. 7, 2011 (JP) 2011-048731

(51) Int. Cl. H04N 5/262

(52) U.S. Cl. 348/240.3; 348/E05.055

(57) ABSTRACT

An electronic device according to the invention includes an operating mechanism, wherein the operating mechanism includes an operating member that is attached so as to reciprocate on a straight line or a circular arc line with respect to a casing, and an elastic member that is interposed between the casing and the operating member to apply an elastic repulsion force to operation of the operating portion, and the elastic member is attached to the operating member by a detachment prevention portion that prevents detachment from the operating member.

This application claims priority based on Japanese Patent Application No. 2011-48731, the content of which is hereby incorporated by reference.

### BACKGROUND OF THE INVENTION

1. Field of the Invention

The present invention relates to electronic devices such as digital cameras, video cameras, and the like.

2. Description of Related Art

Digital cameras and video cameras include an operating portion for a zoom operation in a casing, and the operating portion is connected to a zoom variable apparatus inside the casing via a zoom operating mechanism. The zoom operating mechanism includes an operating member in which the operating portion is provided in a protruding manner and which can rotate with respect to the casing, and a torsion spring which rotationally biases the operating member with respect to the casing, and the torsion spring is structured such that a coil portion is fastened to the casing by a screw, and an elastic repulsion force is applied to the rotation in both directions of the operating member by a pair of arm portions which protrude outward form the coil portion. Accordingly, when the operating portion is operated in any one direction against elasticity of the torsion spring, the zoom variable apparatus is actuated in conjunction with the rotation of the operating member.

In the zoom operating mechanism mentioned above, the torsion spring is fixed to the casing by the screw.

On the other hand, as another zoom operating mechanism of the zoom operating mechanism in which the torsion spring is fixed to the casing by the screw, a zoom operating mechanism shown in FIGS. 10 to 12 has been employed.

The zoom operating mechanism is provided with a circular attaching portion 91 which is formed in a cover cabinet 9 constructing a casing, a zoom operating knob 96 which is arranged rotatably in a front face side of the attaching portion 91, a spring retaining piece 99 which is arranged rotatably in aback face side of the attaching portion 91, and a torsion spring 98 which is interposed between the attaching portion 91 and the spring retaining piece 99, and the zoom operating knob 96 and the spring retaining piece 99 are connected to each other by screws 100, 100, and rotate integrally in both directions.

An operating portion 97 is provided in a protruding manner in the zoom operating knob 96. Further, on a surface of the zoom operating knob 96, a shutter button 94 is installed in a center portion thereof via a coil spring 95.

In an assembling step before the spring retaining piece 99 is connected to the zoom operating knob 96, the torsion spring 98 is temporarily fixed to the attaching portion 91 of the cover cabinet 9 in a state where both arm portions are brought into pressure contact with a pair of pins 92, 92 of the cover cabinet 9 as shown in FIG. 11 by an elastic repulsion force.

In this state, a pair of pressing walls 99a, 99a formed in the spring retaining piece 99 as shown in FIG. 12 are oppositely arranged on both sides of the torsion spring 98 with both leading end portions of the pair of arm portions of the torsion spring 98 therebetween.

Accordingly, when the operating portion 97 of the zoom operating knob 96 shown in FIG. 10 is operated in any one direction, the zoom operating knob 96 and the spring retaining piece 99 integrally rotate, and any one of the pressing walls 99 of the spring retaining piece 99 presses any one of the leading end portions of the torsion spring 98 by the rotation of the spring retaining piece 99, thereby elastically deforming the torsion spring 98.

In conjunction with the rotation of the spring retaining piece 99, the zoom variable apparatus (not illustrated) is actuated.

Thereafter, by releasing the zoom operating knob 96, the zoom operating knob 96 is returned to its original neutral position by the biasing of the torsion spring 98.

In the assembling step of the zoom operating mechanism shown in FIGS. 10 to 12, the torsion spring 98 is temporarily fastened to the cover cabinet 9 as shown in FIG. 11, and then, the spring retaining piece 99 is fastened by the screws so as to be fixed to the zoom operating knob 96 as shown in FIG. 10.

In this case, the torsion spring 98 is simply temporarily fastened to the cover cabinet 9.

However, in the assembling step of the zoom operating mechanism shown in FIGS. 10 to 12, when the spring retaining piece 99 is fixed to the zoom operating knob 96 in a state where the torsion spring 98 is temporarily fastened to the cover cabinet 9 as shown in FIG. 11, the spring retaining piece 99 may come into contact with the torsion spring 98, and the torsion spring 98 may be detached from the cover cabinet 9 by the elastic repulsion force. Therefore, there has been a problem that it is difficult to carry out assembling work of the zoom operating mechanism with respect to the cover cabinet 9.

### SUMMARY OF THE INVENTION

An electronic device according to the present invention includes an operating mechanism having an operating portion, wherein the operating mechanism includes an operating member that is attached so as to reciprocate on a straight line or a circular arc line with respect to a casing, and an elastic member that is interposed between the casing and the operating member to apply an elastic repulsion force to operation of the operating portion, and the elastic member is attached to the operating member by a detachment prevention portion that prevents detachment from the operating member.

In the electronic device of the present invention, the elastic member is elastically deformed by operating the operating portion in one direction and moving the operating member in one direction along the straight line or the circular arc line, and a change is generated in one function (for example, a zoom function) to be achieved by the device, by the movement of the operating member.

Thereafter, by releasing the operating portion, the operating member is returned to its original position by the elastic repulsion force of the elastic member.

In an assembling step of the operating mechanism according to the present invention, the operating member is assembled to the casing after the elastic member is attached to the operating member by the detachment prevention portion. At this time, since the elastic member is prevented from being detached from the operating member, there is a low possibility that the elastic member is detached from the operating member. Accordingly, assembling work of the operating mechanism becomes easy.

### BRIEF DESCRIPTION OF THE DRAWINGS

FIG. 1 is a perspective view of a digital camera which is an embodiment of the present invention;

FIG. 2 is a view of a neutral state of a zoom operating mechanism in the digital camera as seen from a back face side of a cover cabinet;

FIG. 3 is a view of a state in which the zoom operating mechanism in the digital camera is operated in one direction as seen from the back face side of the cover cabinet;

FIG. 4 is a view showing a state in which a spring retaining piece is detached from the zoom operating mechanism shown in FIG. 2;

FIG. 5 is an exploded perspective view of the zoom operating mechanism in the digital camera;

FIG. 6 is an enlarged perspective view of the spring retaining piece to which a torsion spring is attached;

FIG. 7 is an enlarged perspective view showing a state in which the torsion spring is detached from the spring retaining piece;

FIG. 8 is an enlarged perspective view as seen from a different direction from FIG. 6;

FIG. 9 is an enlarged perspective view as seen from a different direction from FIG. 7;

FIG. 10 is a perspective view showing a zoom operating mechanism in a conventional digital camera;

FIG. 11 is a back view of the zoom operating mechanism in the conventional digital camera; and

FIG. 12 is an exploded perspective view of the zoom operating mechanism in the conventional digital camera.

### DETAILED DESCRIPTION OF THE EMBODIMENT

An embodiment in which the present invention is applied to a digital camera will be specifically described with reference to the accompanying drawings. As shown in FIG. 1, the digital camera as one embodiment of the present invention is provided with a photographing lens 11 in a front face portion of a casing 1, and an operating member 4 having a shutter button 3 and an operating portion 51 arranged in a cover cabinet 2 forming an upper wall of the casing 1.

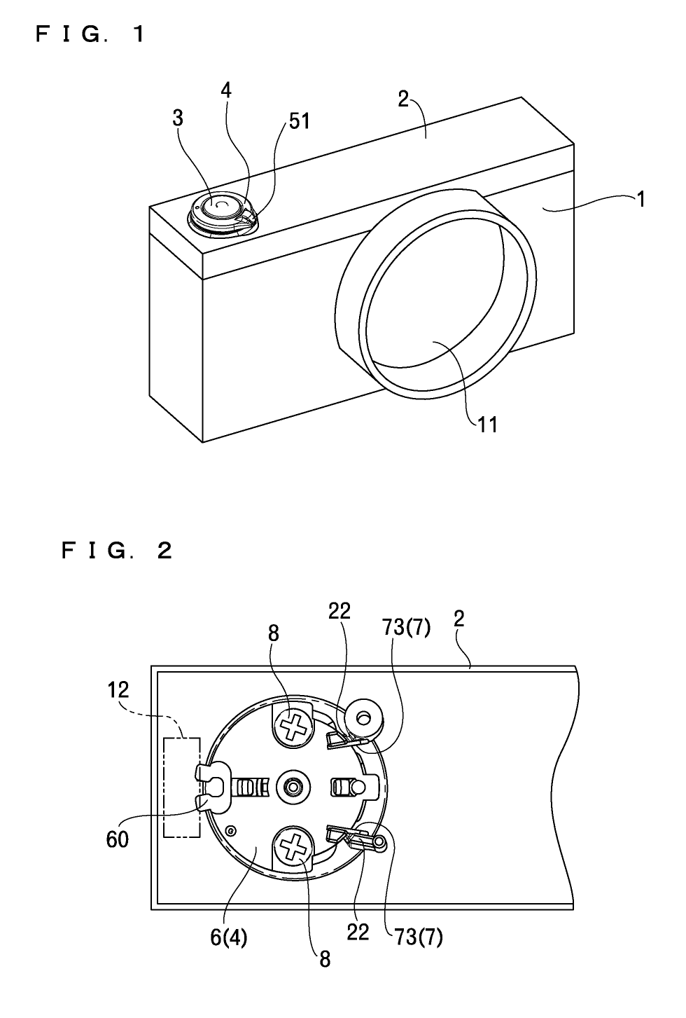

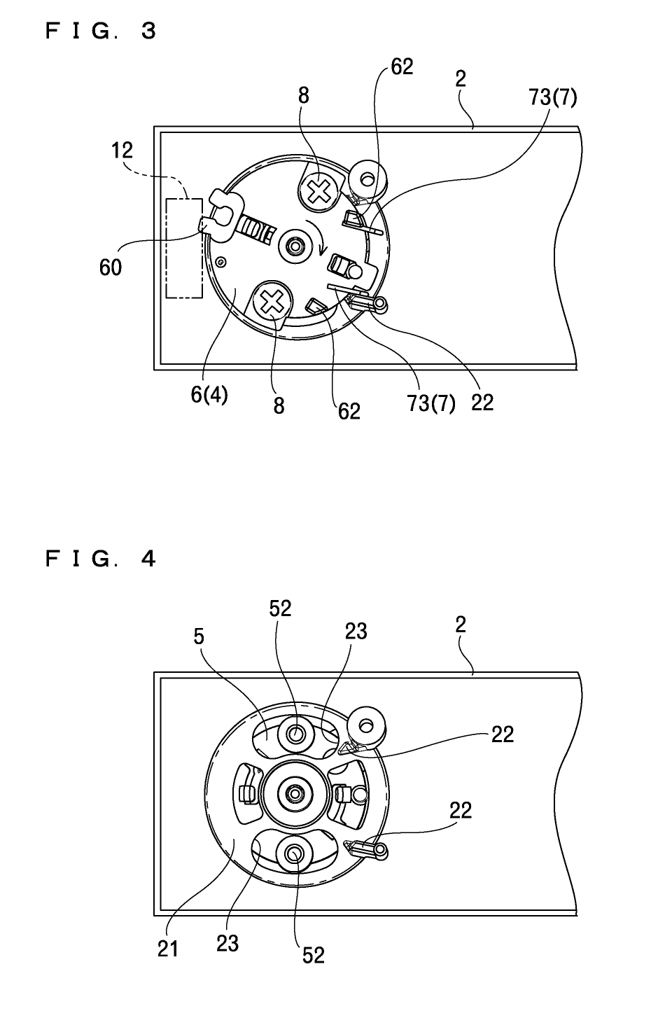

When the operating portion 51 is rotationally operated in any one direction, the operating member 4 rotates from the neutral position shown in FIG. 2 to one end of rotation shown in FIG. 3, for example, and a zoom variable apparatus 12 is actuated. The zoom variable apparatus 12 is a function portion which is connected with a connecting portion 60 formed in the operating member 4. Specifically, the zoom variable apparatus 12 has a mechanical structure such as a well-known optical mechanism, and an electric structure such as a switch.

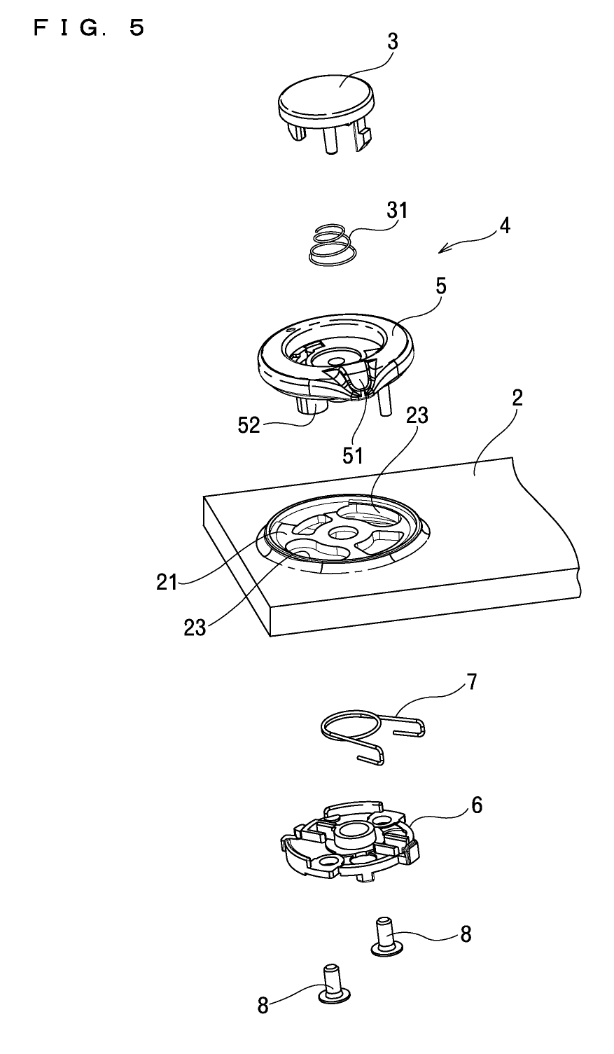

As shown in FIG. 5, the operating member 4 is provided with a discoid zoom operating knob 5 which is arranged in a front face side of a circular attaching portion 21 formed in the cover cabinet 2, a discoid spring retaining piece 6 which is arranged in a back face side of the attaching portion 21, a torsion spring 7 which is interposed between the cover cabinet 2 and the spring retaining piece 6, and two screws 8, 8 which fix the spring retaining piece 6 to the zoom operating knob 5.

An operating portion 51 is provided in the zoom operating knob 5 in a protruding manner. Further, a shutter button 3 is arranged in a center portion of the zoom operating knob 5 via a coil spring 31.

The attaching portion 21 of the cover cabinet 2 is provided with a pair of circular arc holes 23, 23 through which the screws 8, 8 pass. Further, as shown in FIG. 4, a pair of bosses 52, 52 into which the screws 8, 8 are screwed are provided in a protruding manner in a back face of the zoom operating knob 5.

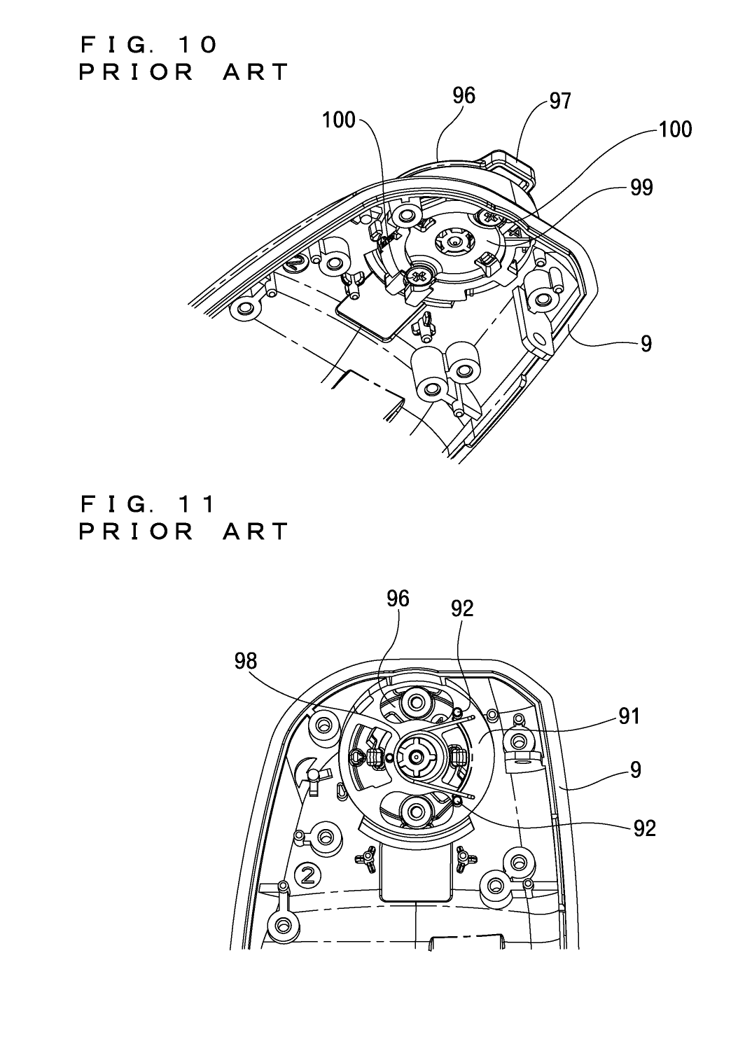

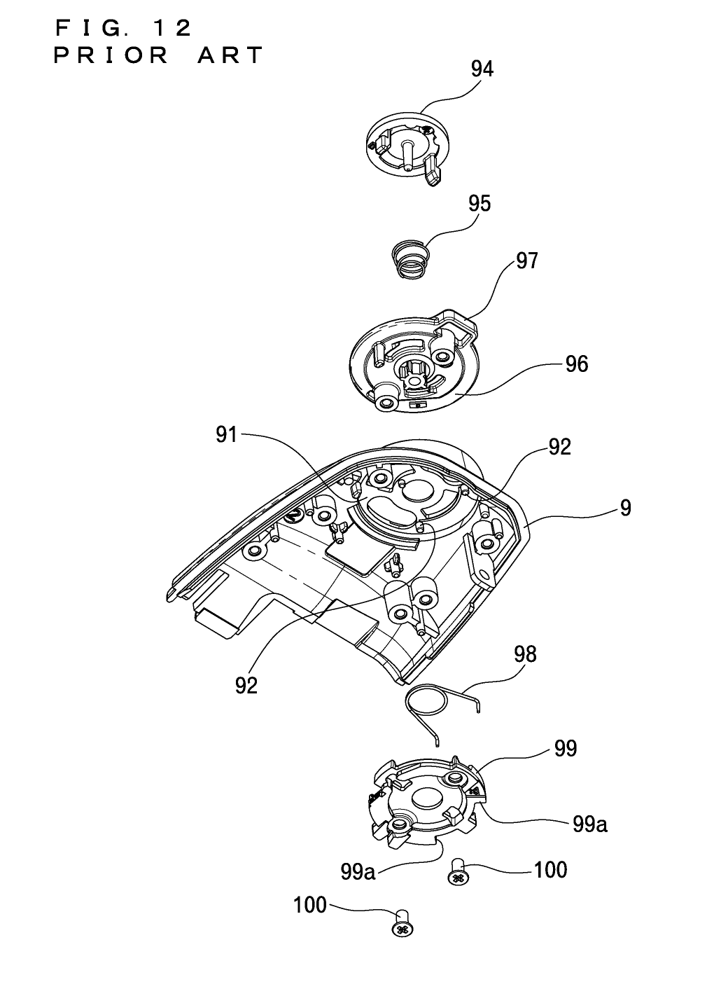

As shown in FIGS. 7 and 9, the torsion spring 7 includes a coil portion 71, and a pair of arm portions 72, 72 which protrude outward from the coil portion 71 and have elasticity in an expanding and contracting direction, and U-shaped portions 73, 73 bent in an U-shape are formed in leading end portions of the arm portions 72, 72.

The spring retaining piece 6 is provided with a boss 64 in a center portion of a circular plate portion 61, and is provided with a pair of protruding pieces 62, 62 in a back face of the circular plate portion 61, and both sides of the boss 64 are provided with a pair of through holes 63, 63 through which the screws 8, 8 pass. Further, a hook piece 65 is provided in a protruding manner in an outer peripheral surface of the boss 64. Further, the connecting portion 60 is formed in an outer peripheral portion of the circular plate portion 61.

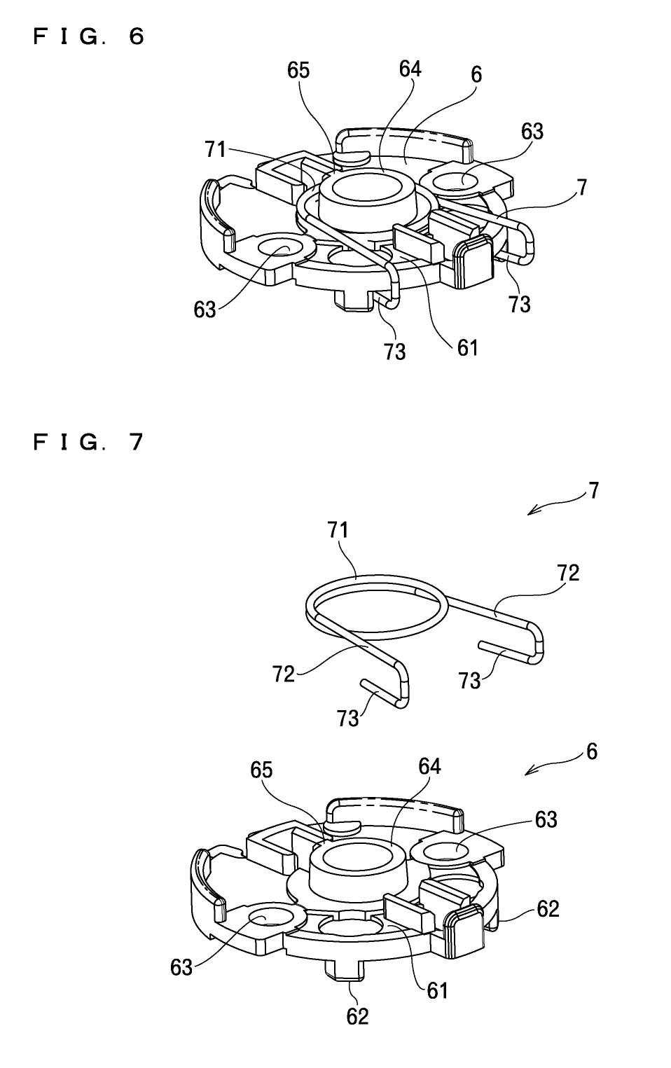

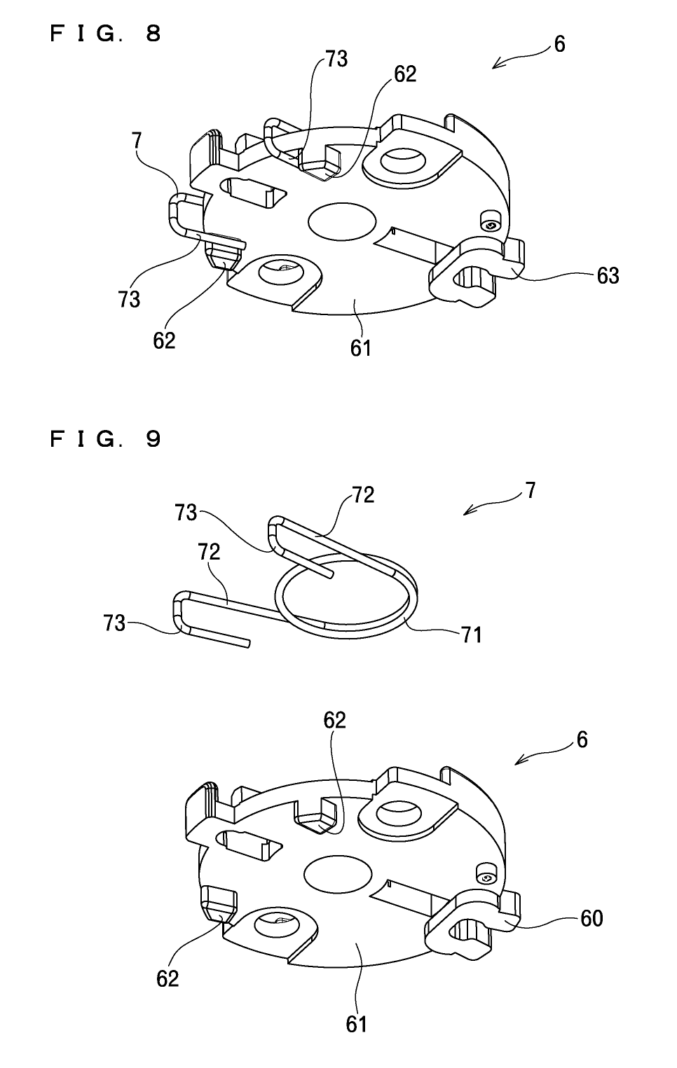

As shown in FIGS. 6 and 8, the torsion spring 7 is installed such that the coil portion 71 surrounds the boss 64 of the spring retaining piece 6, and the coil portion 71 is locked by the hook piece 65 of the boss 64.

Further, the torsion spring 7 is attached to the spring retaining piece 6 in a state where the pair of arm portions 72, 72 extend toward an outer peripheral portion of the spring retaining piece 6, and the U-shaped portions 73, 73 hold an edge portion of an outer peripheral end of the circular plate portion 61 of the spring retaining piece 6 from both sides.

Accordingly, the torsion spring 7 is prevented from being detached from the spring retaining piece 6.

Further, the leading ends of the pair of U-shaped portions 73, 73 of the torsion spring 7 are respectively brought into pressure contact with the inner surfaces of the pair of protruding pieces 62, 62 of the spring retaining piece 6, and an elastic repulsion force in an opening direction of the pair of arm portions 72, 72 of the torsion spring 7 is received (refer to FIG. 2).

In this state, the pair of U-shaped portions 73, 73 of the torsion spring 7 protrude outward from an outer peripheral surface of the spring retaining piece 6.

In a state where the zoom operating mechanism mentioned above is assembled in the cover cabinet 2, as shown in FIG. 2, a pair of receiving pieces 22, 22 of the cover cabinet 2 are opposed to each other on both sides of the torsion spring 7 with a pair of U-shaped portions 73, 73 of the torsion spring 7 therebetween.

Accordingly, when the operating portion 51 of the operating member 4 is rotationally operated in any one direction, the operating member 4 rotates in one direction, for example, as shown by an arrow in FIG. 3 from the neutral position shown in FIG. 2, and along with this, one of the protruding pieces 62 presses one of the U-shaped portions 73 of the torsion spring 7. Accordingly, in a state where the other of the U-shaped portions 73 is received by one of the receiving pieces 22 of the cover cabinet 2, the torsion spring 7 elastically deforms in such a direction that the pair of arm portions 72, 72 are closed.

In conjunction with displacement of the connecting portion 60 of the spring retaining piece 6 caused by the rotation of the operating member 4, the zoom variable apparatus (not illustrated) is actuated.

Thereafter, by releasing the operating portion 51, the operating member 4 is returned to the neutral position shown in FIG. 2 by the elastic repulsion force of the torsion spring 7.

In the assembling step of the zoom operating mechanism mentioned above, the torsion spring 7 is attached to the spring retaining piece 6 as shown in FIG. 6 and FIG. 8, and then, the zoom operating knob 5 and the spring retaining piece 6 are arranged on both sides of the attaching portion 21 of the cover cabinet 2 shown in FIG. 5, and the spring retaining piece 6 is fixed to the zoom operating knob 5 by the screws 8, 8 (refer to FIG. 3).

In this case, since the torsion spring 7 is prevented from being detached from the spring retaining piece 6 as mentioned above, the torsion spring 7 does not easily detach from the spring retaining piece 6 when the spring retaining piece 6 is fixed to the zoom operating knob 5. Accordingly, assembling work of the zoom operating mechanism becomes easy.

It should be noted that the structure of each of the portions of the present invention is not limited to the above embodiment, but can be variously modified by those skilled in the art within a range which does not depart from the scope of the present invention described in the claims. For example, the torsion spring 7 may be attached to the back face of the zoom operating knob 5, and in this case, the zoom operating knob 5 is attached to the attaching portion 21 of the cover cabinet 2 while the torsion spring 7 is attached to the zoom operating knob 5.

Further, it is possible to employ various well-known elastic members, for example, a leaf spring, rubber, a spongy synthetic resin (a sponge) and the like in place of the torsion spring 7.

Further, the operating member 4 is not limited to a rotating member, but may be a member which reciprocates on a straight line.

Furthermore, the present invention is not limited to a digital camera, but can be applied to various electronic devices having an operating portion. In this case, the operating mechanism is not limited to a zoom variable apparatus, but can be connected to various function portions which construct the device.

What is claimed is:

1. An electronic device comprising:
an operating mechanism having an operating portion, wherein
the operating mechanism includes
an operating member that is attached so as to reciprocate on a straight line or a circular arc line with respect to a casing, and
an elastic member that is interposed between the casing and the operating member to apply an elastic repulsion force to operation of the operating portion, and
the elastic member is attached to the operating member by a detachment prevention portion that prevents detachment from the operating member.

2. The electronic device according to claim 1, wherein
the operating member is structured by connecting a first constructing member having the operating portion, and a second constructing member connected to a function portion inside the casing so as to integrally move with each other,
the elastic member is attached to any one of the first constructing member and the second constructing member, and
the function portion changes a function in conjunction with a movement of the second constructing member.

3. The electronic device according to claim 2, wherein
the elastic member is a torsion spring,
the torsion spring includes a coil portion and a pair of arm portions that protrude outward from the coil portion to exhibit elasticity in an expanding and contracting direction,
the coil portion is supported on one of the constructing members, and both leading end portions of the pair of arm portions are brought into contact with a pair of protruding pieces that are formed in the one constructing member and receive elastic deformation in the expanding and contracting direction of both of the arm portions, and
a pair of receiving pieces are formed in the casing on both sides of the torsion spring with both leading end portions of a pair of arm portions of the torsion spring therebetween.

4. The electronic device according to claim 3, wherein
U-shaped portions bent in a U-shape are respectively formed in both of the leading end portions of the pair of arm portions of the torsion spring,
the U-shaped portions hold an end edge portion of the one constructing member from both sides thereof so as to be engaged with the end edge portion,
leading ends of the U-shaped portions come into contact with the protruding piece, and
the detachment prevention portion is constructed by the U-shaped portions.
